(19) United States
(12) Patent Application Publication
(10) Pub. No.: US 2011/0119905 A1
(43) Pub. Date: May 26, 2011

(54) DEVICE FOR INSTALLING A BOTTOM ROLLER IN A GALANIZING TANK USED FOR THE GALVANIZATION OF A CONTINUOUSLY-MOVING STEEL STRIP

(75) Inventors: Pierre Bourgier, Sorbiers (FR); Jean-Jacques Hardy, Irigny (FR)

(73) Assignee: SIEMENS VAI METALS TECHNOLOGIES SAS, Saint-Chamond (FR)

(21) Appl. No.: 13/055,205

(22) PCT Filed: Jul. 21, 2008
(86) PCT No.: PCT/FR08/01075

§ 371 Date: Feb. 3, 2011

(51) Int. Cl. B23P 19/04

(52) U.S. Cl. 29/724

(57) ABSTRACT

A device for installing at least one roller in a liquid zinc bath in a galvanizing line used for the galvanization of a continuously-moving steel strip has a beam to which a first pair of arms is attached. The first pair of arms bears a bottom roller. The bottom roller is intended to be submerged in the liquid zinc bath towards a bottom roller operation position, relative to the naturally submerged position of the bottom roller, by way of a movement provided together with a first cylindrical bearing attached to each of the two ends of the beam and supporting the first pair of arms. A second cylindrical bearing is attached to each of the two ends of the beam and separate from the first cylindrical bearing on the same beam end section. A push device interacts with at least one of the first and second cylindrical bearings such that, in the operation position, the first and second cylindrical bearings are maintained in a single predetermined plane and such that the first cylindrical bearing is disposed under the second cylindrical bearing at a minimum supporting height along a vertical plane.

The invention relates to a device for installing at least one bottom roller in a bath of liquid zinc of a galvanization line for continuously-moving steel strip according to the preamble to claim 1.

The following figures and their descriptions enable, within the technical domain of the invention, to better understand the related prior art:

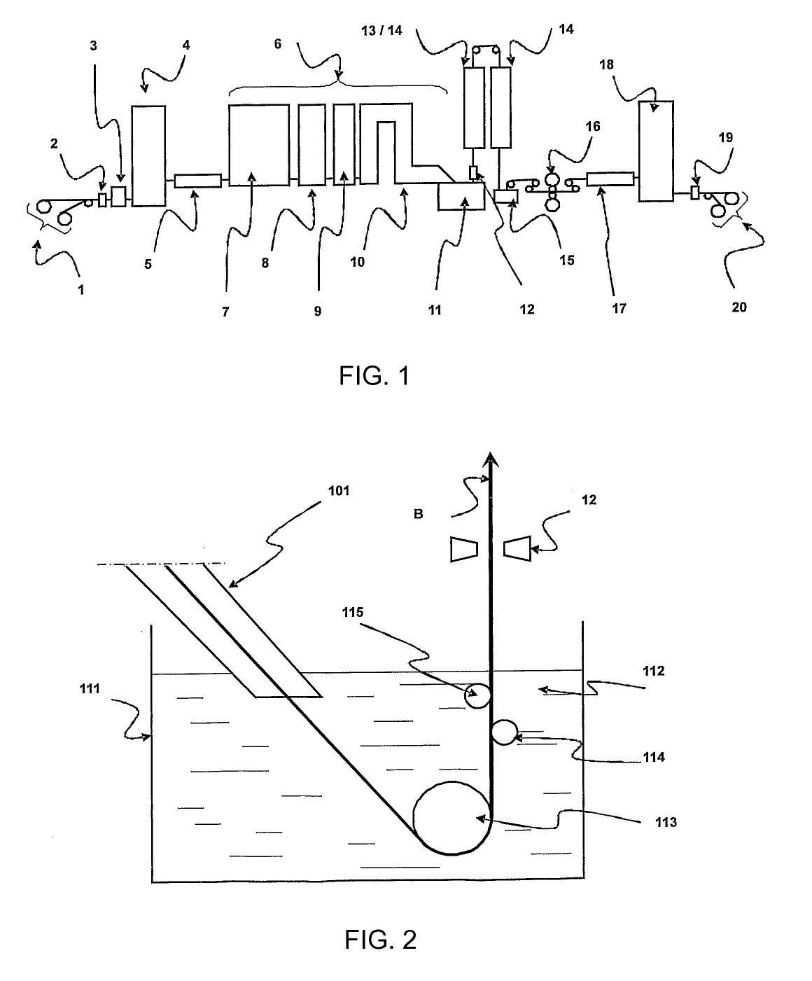

FIG. 1: Typical arrangement of a hot-dip galvanization line for continuously-moving steel strip.

FIG. 2: Typical arrangement of the zinc bath zone.

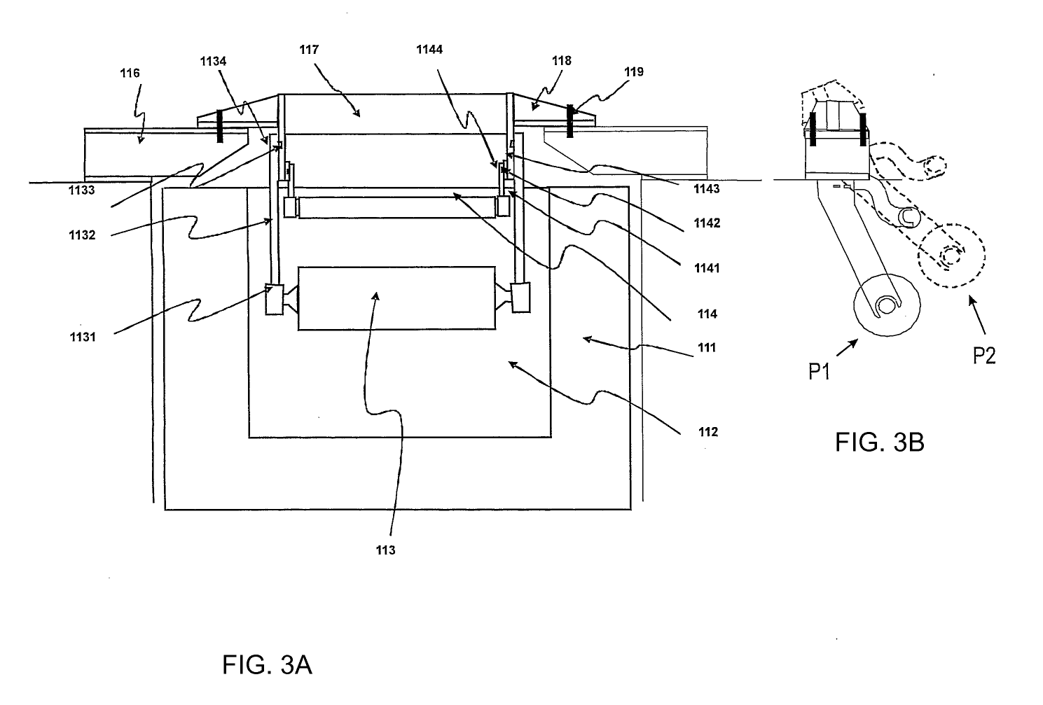

FIG. 3: Typical construction of a bottom roller and pass-line roller bearing.

In order to improve the resistance of the steel against corrosion in certain applications such as in the building, automotive and domestic appliance industries, a coating of zinc or zinc-based alloy is laid onto the surface of the steel strips. This coating is effected on a continuous galvanization line according to FIG. 1 that describes a typical arrangement of a hot-dip galvanization line for continuously-moving steel strips which typically comprises:
An entry section with one or two strip uncoilers 1, a guillotine shear 2, a butt welder 3 for connecting a tail of a strip coming out of one of the uncoilers 1 to the head of a following strip coming out of the other uncoiler 1 and thus ensuring the continuous operation of the line, a strip accumulator 4 which returns to the line the strip previously accumulated while uncoiling upstream of the accumulator is stopped to effect a butt weld,
A degreasing section 5 for cold-rolled strips or an acid-pickling section for hot-rolled strips,
An annealing furnace 6 comprising a heating section 7, a maintenance section 8, a cooling section 9 and a temperature-controlled holding section 10 for the strip before its entry in the zinc bath,
A galvanization section 11 comprising the zinc bath itself in which is immersed the continuously-moving steel strip, a device for draining the liquid zinc 12 placed on the strip, possibly an induction alloying furnace 13, a cooler 14 and a strip dip tank 15,
An exiting section with a mill 16 of the type known as “skin-pass”, a passivation section 17, an exit accumulator 18, a shear 19 and one or two recoilers 20 for the previously galvanized strip.

FIG. 2 describes a typical zinc-coating arrangement for a steel strip B moving continuously through a liquid-zinc alloying bath 112. Strip B thus exiting a sleeve 101 of a temperature-controlled holding section (section 10, FIG. 1) drops obliquely into the liquid-zinc bath 112 contained inside a coating tank 111. Strip B is then diverted vertically by a bottom roller 113 immersed in the tank, then comes into contact with an anti-cupping roller 114 intended to correct any transverse curvature of the strip caused by passing over the bottom roller, then on a pass-line roller 115 intended to adjust the final vertical trajectory of the strip B exiting the coating bath. On its exit from the liquid-zinc coating bath, the strip B is thus coated, on both faces, with a layer of liquid zinc of a more or less constant thickness that is leveled transversally and longitudinally between the draining devices 12 (see also FIG. 1) for the liquid zinc.

This arrangement of elements intended to divert and support the strip in the liquid-zinc bath involves a set of structures able to support and hold said elements immersed in the bath, elements that are required to ensure the continuous movement of the strip through the bath. As a general rule, this set of elements includes supports fixed to the ground on either side of a trench containing a liquid-zinc crucible, a structure supporting the bottom roller and the pass-line roller, a structure supporting the anti-cupping roller and elements for fixing said structures to the supports fixed to the ground.

The operating conditions for the immersed rollers are very difficult, as they and the bearings supporting the ends of each of the rollers are subjected to inevitable deterioration, which means they have to be maintained at short intervals, around 1 to 3 weeks depending on the quality required for the coated strip. This maintenance involves replacing the damaged equipment with replacement equipment in order to restart the galvanization line with a minimum of time lost. The roller supports are thus disconnected from a bearing structure located on either side of the liquid-zinc crucible and moved to a maintenance workshop where the rollers are removed, cleaned of zinc residues, their barrels re-machined if necessary and the support bearings are changed. The rollers and their reconditioned bearings are then replaced onto the structures and their positions are adjusted to the fixing elements of the supports on the maintenance structures. The equipment is then ready to be reassembled on the line.

This reassembly on the galvanization line is moreover preceded by a preheating of the supports and the rollers to a temperature close to the operating temperature in the bath, in particular to offset, before immersion and fixing, the inevitable expansion of the rollers and the metal supports that hold them. Said roller-bearing supports are then raised by a support means, such as an overhead crane often combined with a lifting beam, and are immersed in the liquid-zinc bath.

Under the effect of hydrostatic thrust applied first to the bottom roller then to the entire immersed structure, the position of the center of gravity of the whole varies constantly during the immersion, making it difficult to guide the roller to markers or fixing supports, in particular in a high-temperature environment which is hostile to the operators undertaking such guidance. In consideration moreover of the bent shape of the structure bearing the bottom roller and the pass-line roller as well as a position of said rollers that may change as a function of their wear, in relation to a position of the fixing elements of the roller-bearing structures on the ground supports, the naturally immersed position is variable and makes it impossible to ensure perfect contact of the supporting structure fixing plates and the ground supports. An inevitable incline of the contact faces of these plates must then be compensated by tightening the fixing elements until correct contact is assured making it possible to effect a final tightening of said fixing elements in the case of combined screw-nut systems and to ensure the implementation of the structure bearing the bottom roller and the pass-line roller in its working position. Such an operation, in consideration of the masses in play, is often long and arduous for operators and inevitably extends the time they spend in the hostile zone of the crucible/liquid-zinc bath.

A major object of this invention is to provide a device for the installation (immersion, withdrawal) of the roller in a liquid galvanization bath for a continuously-moving steel strip, said installation requiring no human intervention in its environment.

This device should further simplify and speed up the use of positioning and fixing elements after installation of the roller (up to blocking/locking), as said elements can also be controlled remotely.

Finally, it should be possible to implement this device in new installations or in place of normal devices on existing installations.

A device designed to install at least one roller in a bath of liquid zinc of a galvanization line for a continuously-moving steel strip is therefore proposed as claimed in claim 1.

The embodiments of said device and their advantageous aspects are also re-transcribed by a set of sub-claims.

The object of the invention and its advantages can be better understood through the examples provided by the following figures:

FIGS. 3a, 3b: typical device of a support for a bottom roller and a pass-line roller (FIGS. 3a, 3b representing respectively a front elevation and a side elevation in relation to the continuous movement of the steel strip);

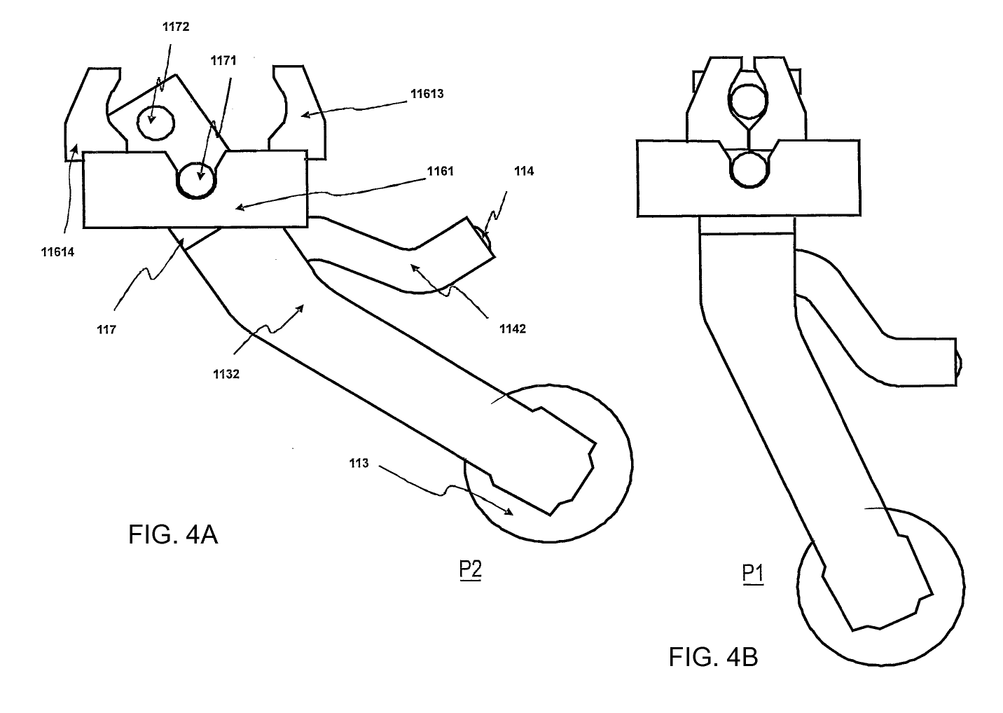

FIGS. 4a, 4b: First embodiment of a device designed to install a bottom roller and a pass-line roller according to the invention;

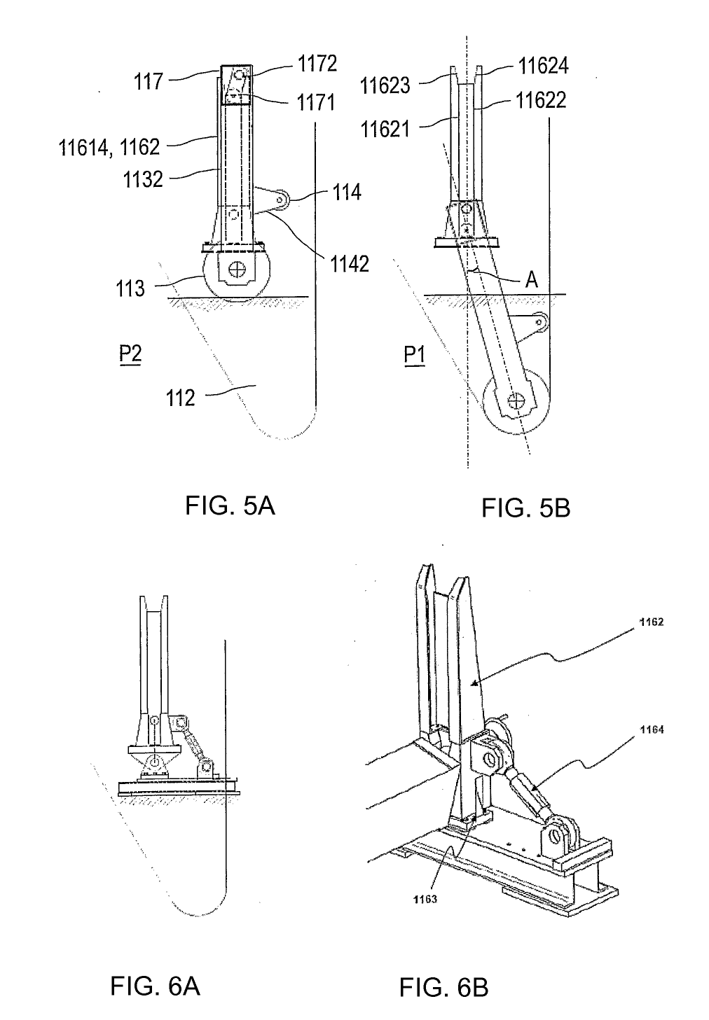

FIGS. 5a, 5b: Second embodiment of a support for a bottom roller and a pass-line roller according to the invention;

FIG. 6a, 6b: Variant of the second embodiment.

FIG. 3a (and FIG. 3b to better understand the device in perspective) shows a typical device for supporting a bottom roller and a pass-line roller designed for an installation of at least one (bottom) roller (113) in a liquid-zinc bath (112) of a galvanization line for a continuously-moving steel strip (not shown), comprising a beam (117), to which is attached a first pair of arms (1132), the first pair of arms (1132) bearing the bottom roller (113) whose rotational axis is connected to each lower end (1131) of each arm (1132), the roller being intended to be immersed in the liquid-zinc bath (112) by a movement means of the first pair of arms towards a working position (P1) of the bottom roller relative to a naturally immersed position (P2) of the bottom roller under the effect of hydrostatic thrust.

The installation according to FIGS. 3a, 3b includes more specifically a load-bearing structure comprising two supports (116) placed above and on either side of a trench containing the coating tank (111), itself comprising the zinc bath (112). On these supports (116), the beam (117) extended by the fixing brackets (118) is attached by bolts (119) above the liquid bath (112). The bottom roller (113) is carried by two bearings (1131) themselves connected to the two arms (1132) that are assembled with the beam (117) adjustably using a key or slideway system (1133) and fixing bolts (1134). In the same way, a pass-line roller (114) is carried by two bearings (1141) themselves connected to two arms (1142) that are assembled with the two arms (1132) adjustably using a key or slideway system (1143) and fixing bolts (1144). The movements (here in the form of the roller arms swinging) towards the working position (P1) and the naturally immersed position (P2) of the bottom roller and the pass-line roller are therefore synchronous, such as to immerse or remove the two rollers into/out of the zinc bath.

FIGS. 4a, 4b show a first embodiment of a device designed to install a bottom roller and a pass-line roller according to the invention.

More specifically, this first device according to the invention is designed to install at least one roller in a liquid-zinc bath of a galvanization line of a continuously-moving steel strip (B), comprising a beam (117), to which is attached a first (1132) pair of arms, the first pair of arms (1132) bearing a bottom roller (113), the roller being designed to be immersed in the liquid-zinc bath (112) (by a movement means of the first pair of arms) to a working position of the bottom roller (P1, FIG. 4b where the bottom roller is submersed to its complete-immersion position in the zinc bath, said position being predefined and adapted for galvanization of the strip) relative to a naturally immersed position of the bottom roller (P2, FIG. 4a where the bottom roller can be considered to be kept “floating” on the zinc bath), by means of a movement effected in cooperation with a first cylindrical bearing (1171) supporting said first pair of arms, said first cylindrical bearing (1171) being fixed to both ends of the beam (117). Said device according to the invention is characterized by:

a) a second cylindrical bearing (1172) attached to both ends of the beam (117) and separate from the first cylindrical bearing (1171) on the same beam end section (117),
b) a push device (11614) which interacts with at least one of the first and second cylindrical bearings (1171, 1172) such that in working position, the first and second cylindrical bearings (1171, 1172) are maintained in a single predetermined plane (in this case vertical), and such that the first cylindrical bearing (1171) is disposed under the second cylindrical bearing (1172).

The cylindrical bearings (1171, 1172) are thus comparable to support axles/bars or rollers, fixed to and protruding from the side sections of the beam (117), said beam (117) itself supporting the first pair of arms (1132). A second pair of arms (1142) supporting a pass-line roller (114) may also be fixed to the beam (117) or the first arm (1132) to ensure a synchronous movement of the bottom (113) and pass-line rollers (114).

For this purpose, the push device comprises a first pushing element (11614) designed to swing the second cylindrical bearing (1172) in relation to the first cylindrical bearing (1171) seated in an aperture of a load-bearing half-bearing (1161), such that it can turn freely around its own axis between the two positions known as immersed and raised. This first pushing element ideally has a contact surface having a curvature adapted to the cylindricity of the second cylindrical bearing (1172) so that it slides better on this contact surface, in particular during submersion.

To achieve greater positional stability towards the working position, the push device may also include a second push element (11613) cooperating by means of reactive (and synchronous) movement with the first pusher (11614) such as to grip the second cylindrical bearing (1172) in the working position of the bottom roller. In this way, the two cylindrical bearings (1171, 1172) are locked and ensure a precise and stable working position of the bottom roller, in particular when it is rotating when the strip is moving. Pushing then clamping by means of the pushing elements (11613, 11614) are effected for example by hydraulic cylinders (not shown). The pushing elements (11613, 11614) of the push device are for example lockable by clamping or using a system of locking levers in the working position required during the galvanization operation. No human intervention is therefore required to submerse the roller(s) or to keep them in galvanizing position.

FIGS. 5a, 5b show a second embodiment of a device designed to install a bottom roller and a pass-line roller according to the invention.

More specifically, this second device according to the invention is designed to install at least one roller in a liquid-zinc bath of a galvanization line of a continuously-moving steel strip (not shown), comprising a beam (117), to which is attached a first (1132) pair of arms, the first pair of arms (1132) bearing a bottom roller (113), the roller being designed to be immersed in the liquid-zinc bath (112) (by a movement means of the first pair of arms) towards a working position (P1, FIG. 5b where the bottom roller is submersed to its complete-immersion position in the zinc bath, said position being predefined and adapted for galvanization of the strip) of the bottom roller relative to a raised position (P2, FIG. 5a where the bottom roller can be considered to be kept “floating” in the zinc bath) or a naturally immersed position of the bottom roller, by means of a movement effected in cooperation with a first cylindrical bearing (1171) supporting said first pair of arms, said first cylindrical bearing (1171) being fixed to both ends of the beam (117). Said device according to the invention is characterized by:

a) a second cylindrical support (1172) attached to both ends of the beam (117) and separate from the first cylindrical bearing (1171) on a single beam end section (117),
b) a push device (11614) which interacts with at least one of the first and second cylindrical bearings (1171, 1172) such that in working position, the first and second cylindrical bearings (1171, 1172) are maintained in a single predetermined plane (in this case near vertical), and such that the first cylindrical bearing (1171) is disposed under the second cylindrical bearing (1172).

For this device and to reach the submerged position of the roller simply by the action of gravity, i.e. from the naturally immersed position to the working position, the push device (11614) comprises two slideway columns (1162) arranged such that the first and second cylindrical bearings (1171, 1172) are prevented from pivoting when they are sliding freely downwards one above the other between two slideway columns (1162) maintaining an angle (A) of the first pair of arms (1132) in relation to the vertical. Indeed, the slideway columns exercise a lateral force on the two cylindrical supports (1171, 1172) or rollers such that the bottom roller is placed at the desired height and lateral distance from the columns (hence the pivot-angle A of the arms) in the zinc bath. In other words, the two cylindrical supports (1171, 1172) are sliders that can notably be lowered by lateral mechanical pressing or pushing between the two columns (1162) so that the bottom roller (113) reaches its final submerged position at a holding angle (A) of the arms (1132). Thus, the guiding they provide is advantageously very precise to ensure a positioning of the bottom roller (113) that is also very precise in the zinc bath (112). These slideways guide the sliders (1171, 1172) by means of guide tracks (11621) and (11622), the tops of which are extended by ramps (11623) and (11624) forming a funnel and therefore ensuring the easy engagement of the sliders (1171, 1172).

A second pair of arms (1142) holding a pass-line roller (114) may also be fixed to the beam (117) or to the first arm (1132) to ensure a synchronous and precise movement of the bottom and pass-line rollers.

Thus, the slideway columns (1162) each have at least one vertical guide track (11621) designed to mechanically guide without human intervention each of the ends of the beam (117) in this case horizontal and connecting the arms of the first pair of arms.

It should be noted that the alignment of the sliders (1171, 1172) in beam section (117) is inclined at the aforementioned angle (A) relative to the first pair of arms (1132). In this way, it is therefore possible to place the sliders in a predefined plane close to vertical in working position and therefore, to incline by precise adjustment the arms and the bottom roller by the angle (A) in the zinc bath (112).

For this purpose, FIGS. 6a, 6b show a variant of the second embodiment of the device according to the invention (in relation to FIGS. 5a, 5b). FIG. 6a shows a side elevation of the device as in FIGS. 5a, 5b. FIG. 6b shows a perspective view of FIG. 6a.

For this variant, the slideway columns (1162) (initially guiding roller submersion) are themselves able to pivot around a horizontal axis supported by a clevis (1163) beneath said columns and actuated by a turnbuckle or cylinder (1164), placed lateral to the columns and supported on the clevis. This mechanically controllable pivoting makes it possible to adjust the position of the structure to the galvanization position more exactly, i.e. in the working position of the bottom roller and the pass-line roller.

To reach this naturally immersed position (FIG. 5a) of the bottom roller from the working position, the push device can be unlocked keeping the beam away from the slideway columns (1162).

The advantageous technical aspects below are applicable to all embodiments of the device and their variant according to the invention.

To reach the raised or at least naturally immersed position of the bottom roller from the working position, the locking devices are released such as to enable the bottom roller to be removed from the carrying structure using a support means such as an overhead crane. Indeed, the structure carrying the bottom roller and the pass-line roller includes means of locking/unlocking the bottom roller in working position that can ensure a steady positioning of the bottom roller and the pass-line roller during the galvanization phase. These make it possible to lock the two cylindrical bearings in the predefined plane (vertical or near vertical) in order to reach the desired working position in the galvanization bath. When installing the roller to the raised position, one simply unlocks these locking means to enable it to be moved to a maintenance workshop.

1-8. (canceled)

9. A device for installing at least one roller in a liquid zinc bath in a galvanizing line for galvanizing a continuously-moving steel strip, comprising:
a beam having two ends;
a first pair of arms mounted to said beam;
a first cylindrical bearing attached to both said two ends of said beam and supporting said first pair of arms;
said first pair of arms bearing a bottom roller to be immersed in the liquid zinc bath towards a working position of the bottom roller, relative to a naturally immersed position of the bottom roller, by way of a movement provided in cooperation with said first cylindrical bearing supporting said first pair of arms;
a second cylindrical support attached to both said two ends of said beam and separate from said first cylindrical bearing on a single beam end section; and
a push device disposed to interact with at least one of said first cylindrical bearing or said second cylindrical bearings such that, in a working position, said first and second cylindrical bearings are maintained in a single predetermined plane, and said first cylindrical bearing is disposed under said second cylindrical bearing.

10. The device according to claim 9, wherein said push device comprises a first pushing element configured to swing said second cylindrical bearing relative to said first cylindrical bearing, with said first cylindrical bearing seated in an aperture of a load-bearing half-bearing and freely pivotable about an axis thereof.

11. The device according to claim 10, wherein said push device includes a second push element cooperating by way of a reactive movement with said first pusher so as to grip said second cylindrical bearing in the working position of the bottom roller.

12. The device according to claim 9, wherein, in order to reach the working position, said push device comprises two slideway columns arranged to prevent said first and second cylindrical bearings from pivoting as said first and second cylindrical bearings are sliding freely downward one above the other, with said two slideway columns maintaining an given angle of said first pair of arms relative to the vertical.

13. The device according to claim 12, wherein said slideway columns each have at least one vertical guide track configured to guide each of said ends of said horizontal beam and connecting said arms of said first pair of arms.

14. The device according to claim 12, wherein said slideway columns are pivotally mounted around a horizontal axis supported by a clevis under the action of a turnbuckle or cylinder.

15. The device according to claim 12, wherein, to reach the naturally immersed position of the bottom roller from the working position, said push device may be unlocked keeping said beam away from said slideway columns.

16. The device according to claim 9, wherein said push device includes means of locking the bottom roller in a working position suitable for a galvanization phase.
